(19) United States
(12) Patent Application Publication
(10) Pub. No.: US 2002/0089170 A1
(43) Pub. Date: Jul. 11, 2002

(54) Graphic and sound coordinated novelty item and method

(76) Inventor: Frank Taverrite, Las Vegas, NV (US)

Correspondence Address: Dean A. Craine, P.S., Suite 140, 400-112th Ave. NE, Bellevue, WA, 98004, US

(21) Appl. No.: 10/043,982

(22) Filed: Jan. 10, 2002

Related U.S. Application Data
(60) Provisional application No. 60/260,692, filed on Jan. 11, 2001.

(51) Int. Cl. G09F 1/00

(52) U.S. Cl. 283/56

(57) ABSTRACT

A novelty item including an image or picture of a specific activity, object or place printed on one surface with an audio spectrograph tracing or complex waveform that corresponds to the activity, object, or place printed thereon. Optional written phrases describing the sport or activity depicted by the sound waves would appear vertically on the sleeve, or elsewhere on the shirt, such as “surf's up” or “the swing of the club”. Also disclosed is a method of promotion using the above novelty item.

### BACKGROUND OF THE INVENTION

This is a utility patent application based on a provisional patent application (Ser. No. 60/260,692) filed on Jan. 11, 2001.

1. Field of the Invention

This invention pertains to novelty or promotional items, such as T-shirts, hats, coffee mugs, miniature basketballs, etc., and more particularly, to such items with an attention-grabbing image or picture printed thereon.

2. Description of the Related Art

Sellers of novelty or promotional items are looking for new and unique ways to generate interest for these items in their customers. Items that generate an pleasant or humorous idea, thought, or association that lingers in the memory of the customers are especially desirable.

It is common for enthusiasts or supporters of a particular sport or event to wear garments or hats that display an image or picture closely associated with the sport or event. An example of such an item is the well-known image of the professional basketball player, Michael Jordan, stretched out and dunking a basketball, used by Nike, Inc. on its basketball-related clothing and sports gear. Typically, the image or picture is printed or sewn directly onto a visible surface of the garment or hat. While the image or picture is generally considered advertising, it may also be regarded as informational, since it informs the viewer that the wearer supports or follows a particular sport, such as basketball.

Sound is a form of energy created by sound waves that travel through an elastic medium, such as air. Sound waves are longitudinal waves that consist of pressure fluctuations that distort the air.

While it may be possible to produce a simple sound having a specific pitch (frequency), loudness (intensity), and quality (overtone structure), most sounds are a combination of sound waves which are superimposed and may be presented in a complex waveform by an acoustic spectrograph. Most individuals find the presentation of a sound presented in a complex waveform fascinating, and try to pronounce the sound or recall experiences where the sound was heard. The coupling of an object or action depicted in an image to an associated complex waveform can be an effective means of reinforcing the object or action or its meaning in the individual's mind, and is thereby useful as a marketing tool.

What is needed is a novelty or promotional item that combines a selected image or picture printed on a surface with an associated complex waveform that depicts the pronounced name of the activity, or object, or the sound of the activity associated therewith.

### SUMMARY OF THE INVENTION

It is an object of the present invention to provide an improved novelty or promotional item that presents an image of an object or action that is mentally retained by the viewer.

It is another object of the present invention to provide such an item which that requires the viewer to use some degree of reasoning to determine the meaning of the object or action depicted.

It is a further object of the present invention to provide such an item that uses a complex waveform displayed on a visible surface of the item which represents the word or sound closely associated with the image thereby reinforcing the object or activity depicted.

These and other objects of the invention which will become apparent are met by a novelty or promotional item including a garment, such as a T-shirt, sweatshirt, or hat having at least one support surface visible to others. Printed on the support surface is an image or picture with the pronounced name of the activity or object or the sound or the activity associated therewith presented in a complex waveform also printed on the surface. The garment's support surface displays the image and complex waveform so that they are visible to others. The association of the sound to the activity or object reinforces the activity or object in the mind of the viewer thereby improving the retention of the item or activity in the mind of the viewer.

### BRIEF DESCRIPTION OF THE DRAWINGS

FIG. 1 is a front elevational view of a shirt with an image of a basketball player with the complex waveform associated with the sound of a bouncing ball also provided on the front surface of the shirt.

FIG. 2 is an enlarged view of the image and complex waveform shown on the shirt in FIG. 1.

FIG. 3 is a front elevational view of a shirt with an image of a football player being tackled by a second football player with the complex waveform associated therewith provided in the background of the image.

FIG. 4 is an enlarged view of the image and complex waveform shown in FIG. 3.

FIG. 5 is a front elevational view of a shirt with sequential images of swinging golf clubs, golf balls, and golf tees, with the complex waveform associated therewith in the foreground on the front surface of the shirt.

FIG. 6 is an enlarged view of the image and complex waveform shown in FIG. 5.

### DESCRIPTION OF THE PREFERRED EMBODIMENT(S)

Referring to the accompanying Figs., there is shown and described a novelty or promotional item, generally referred to as 10, with an image or picture 11 printed on a visible surface 12 on the item 10, and the associated pronounced name of the activity or object or the sound or the activity associated with the image or picture presented in a complex waveform 30 also printed on the surface 12.

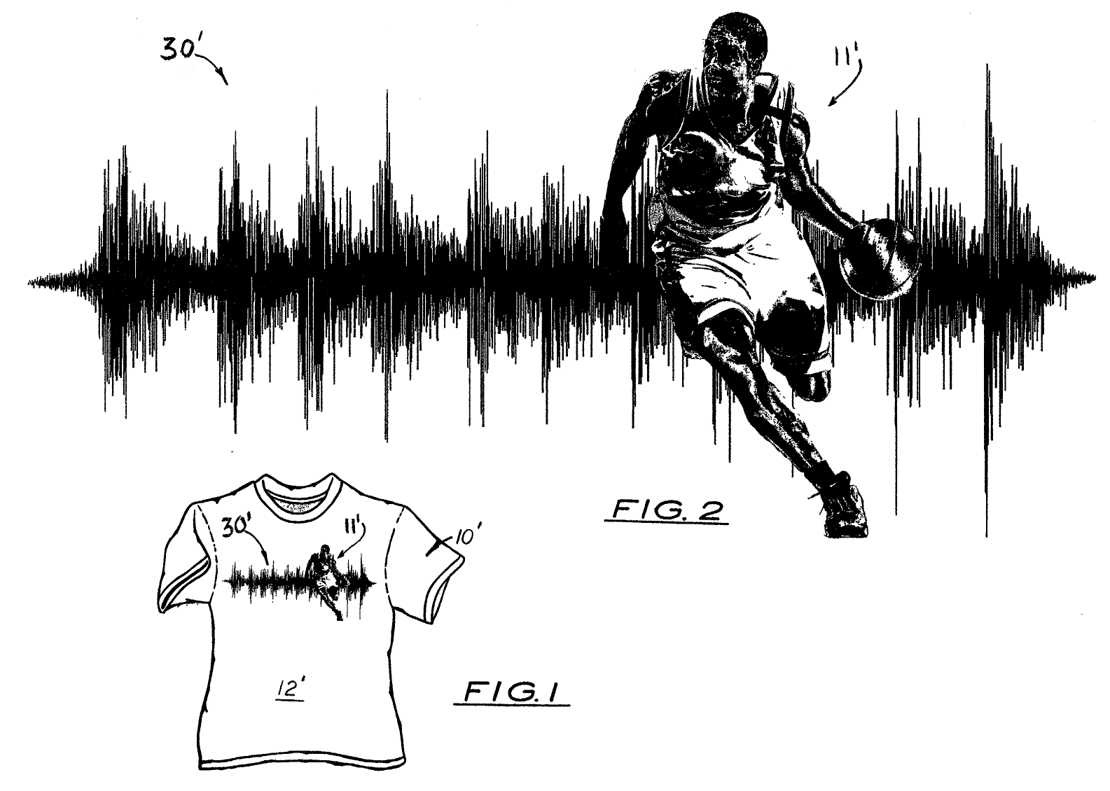

FIG. 1 shows a T-shirt 10′ with a visible front panel 12′ with an image 11′ of a basketball player dribbling a basketball. The complex waveform 30′ associated with the sound of a player bouncing a basketball is presented in the background of the image 11′. The image and sound of a player bouncing a basketball is presented in an enlarged format in FIG. 2.

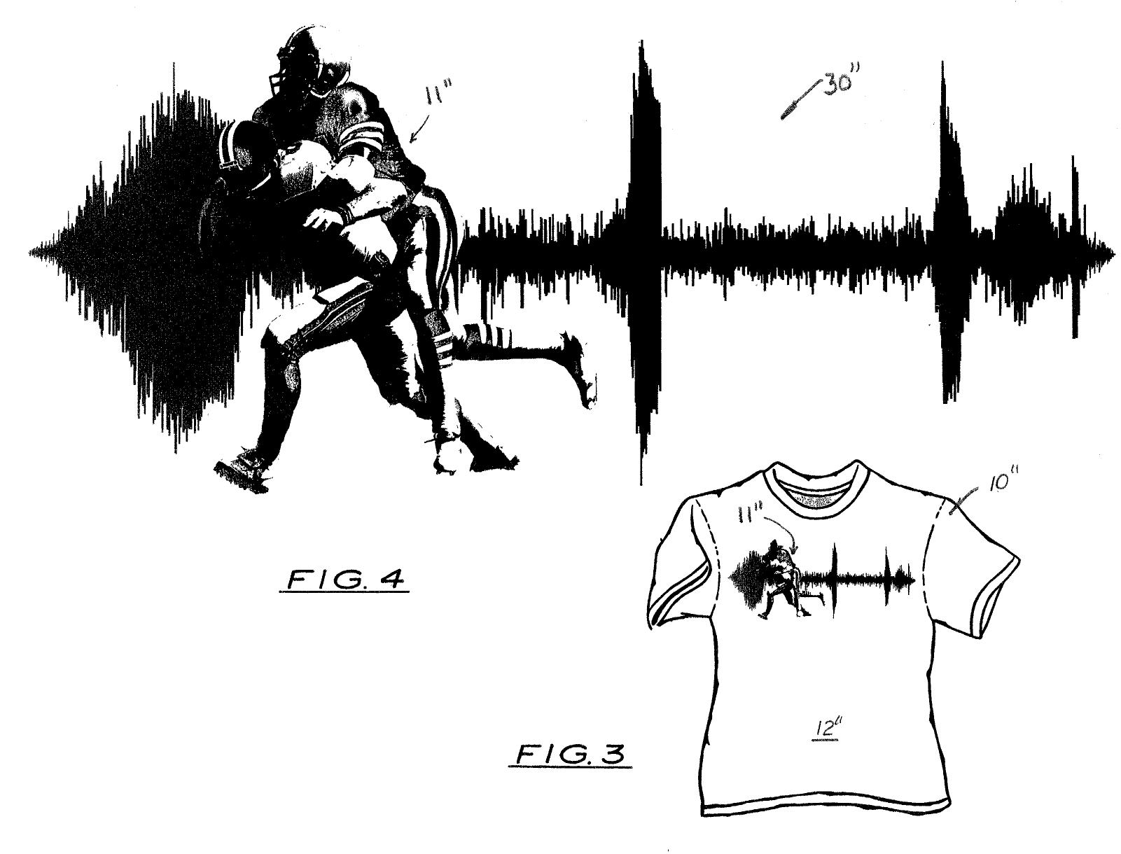

FIG. 3 shows a T-shirt 10″ with a visible front panel 12″ and the image 11″ of a football player being tackled by another football player. The complex waveform 30″ associated with the sound of a football player being tackled by another football player is presented in the background of the image 11″. The image and sound of a player tackling another player is presented in an enlarged format shown in FIG. 4.

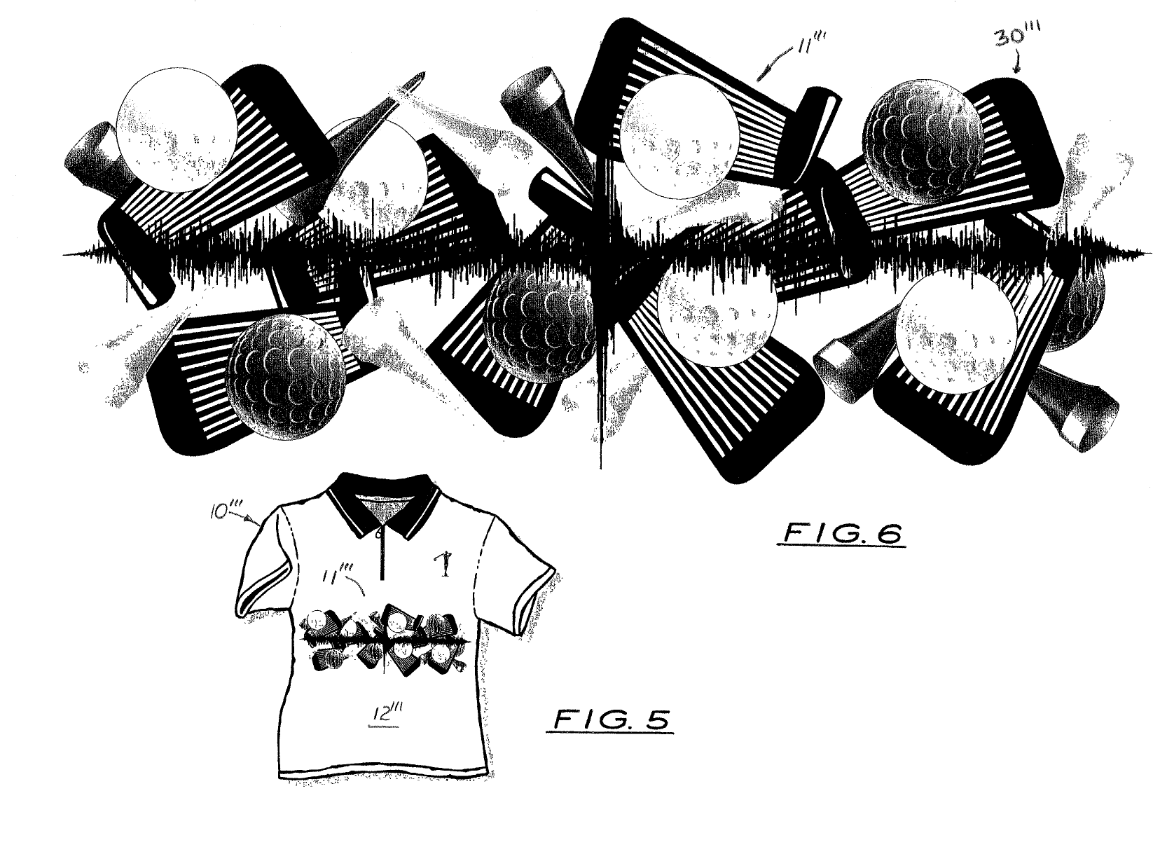

FIG. 5 shows a polo shirt 10″′ with a visible front panel 12″′ with the sequential images 11″′ of golf club heads hitting golf balls off tees. The complex waveform 30″′ associated with the sound of a golf club head hitting a golf ball is presented in the foreground of the image 11″′. The image and sound of a golf club hitting a golf ball off a tee is presented in an enlarged format in FIG. 6.

Using the above described item, a method of promoting a product or service may is provided comprising the following steps:

a. selecting a substrate with a viewing surface;

b. selecting an image of an product or service to be displayed on the viewing surface of said substrate;

c. selecting a sound associated with the image, product or service;

d. printing said image on a visible surface of a garment worn by an individual;

e. creating a complex waveform of the sound, and;

f. printing the complex waveform on the visible surface.

It should be understood that the substrate may be a garment, hat, coat, sports bag, coffee mug, printed literature, poster, etc.

In compliance with the statute, the invention described herein has been described in language more or less specific as to structural features. It should be understood, however, that the invention is not limited to the specific features shown, since the means and construction shown, comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A graphic and sound coordinated novelty item, comprising:
a. a novelty item having a visible surface;
b. a main graphic displayed on said visible surface; and,
c. a complex waveform displayed on said visible surface, said complex waveform associated with said main graphic.

2. A method of promotion, comprising the following steps:
a. selecting a substrate with a viewing surface;
b. selecting an image of an item or activity that promotes a desired product or activity to be printed on said viewing surface of said substrate;
c. selecting a sound associated with said image, said product or said activity;
d. creating a complex waveform of said sound;
e. printing said image on a visible surface on said substrate; and,
f. printing said complex waveform on said substrate.
